(19) United States
(12) Patent Application Publication
(10) Pub. No.: US 2016/0152347 A1
(43) Pub. Date: Jun. 2, 2016

(54) LAUNCH DEVICE FOR REMOTELY CONTROLLED AIRCRAFT

(71) Applicant: THALES, Courbevoie (FR)

(72) Inventors: Luc CARPENTIER, Guyancourt (FR); Thierry GAUTHIER, Guyancourt (FR)

(21) Appl. No.: 14/898,086

(22) PCT Filed: Jun. 10, 2014
(86) PCT No.: PCT/EP2014/062030

§ 371 Date: Feb. 11, 2016

(30) Foreign Application Priority Data
Jun. 14, 2013 (FR) 1301373

(51) Int. Cl. B64F 1/04; B64C 39/02

(52) U.S. Cl. CPC B64F 1/04; B64C 39/024; B64C 2201/08

(57) ABSTRACT

A device to launch a drone, comprises a rail extending along a longitudinal axis and a carriage, mobile on the rail, that can support and launch a drone by the acceleration of the carriage between a loading position and an end-of-travel position, further comprising a spring mechanism configured to exert a return force on the carriage along the longitudinal axis that is substantially constant between the two positions. The spring mechanism comprises at least one coil spring around a hub, one end of the coil spring being linked to the carriage, the return force exerted on the carriage being generated by the coiling of the spring around the hub.

The present invention relates to the field of launch devices for remotely controlled aircraft commonly called drones. More specifically, it relates to a device for placing drones in flight that are of small dimensions and generally dedicated to observation missions.

The drones, also called UAV, which is the acronym for Unmanned Aerial Vehicle, make it possible to carry a payload intended for civilian or military, surveillance, intelligence, combat or transport missions. As flying craft of small size, less expensive and simpler to implement than an aircraft with a pilot on board, the use of drones has expanded significantly. The drones can be categorized by their size, their altitude or their endurance, their maximum payload, or even their stealthy nature. Particularly well-known are the categories of mini-drones and micro-drones intended essentially for observation missions of very small size (typically with a span less than 4 meters) and of limited weight (typically less than 25 kg). The lightest of them can be easily transported by an operator, and launched by that operator according to the needs of the mission. A number of launch means are envisaged. In a simple implementation, the launch is carried out directly by hand by the operator. In other implementations, the impulse needed for the launch is imparted by an elastic-band-powered catapult device of the harpooning gun type, by a compressed air-powered device, or even by means of pyrotechnic substances.

These various known techniques for launching drones of small to medium size do not however cover all the operational needs. It is desirable to have a launcher that is suited to the many requirements of its practical use. In effect, the launcher must on the one hand deliver an impulse that is sufficiently high to impart a speed suitable for the lift-off of the craft, but also sufficiently limited so as not to harm the operation of the on-board systems (such as positioning systems (GPS), inertial unit (IMU)). The launch device must also exhibit a high compactness and a limited weight to be easily transported by the drone operator. It must be quick to install, it must also allow the drone to be launched along a precise trajectory and in a restricted space.

The general idea of the present invention rests on the implementation of a spring mechanism exhibiting a return force that is substantially constant over a large portion of its elongation travel. Such a mechanism makes it possible to optimize the speed imparted on the drone over a launch ramp of limited length, while ensuring that an initial acceleration is observed that is compatible with the mechanical strength of the drone and of its components.

To this end, the subject of the invention is a device intended to launch a drone, comprising a rail extending along a longitudinal axis and a carriage, mobile on the rail, that can support and launch a drone by the acceleration of the carriage between a loading position and an end-of-travel position. The device further comprises a spring mechanism configured to exert a return force on the carriage along the longitudinal axis that is substantially constant between the two positions.

Advantageously, the return force exhibits a maximum deviation less than 10% of a nominal value, over a travel used of the spring mechanism, beyond a minimum elongation value representing less than 10% of the travel used.

Advantageously, the spring mechanism comprises at least one coil spring around a hub, one end of the coil spring being linked to the carriage, the return force exerted on the carriage being generated by the coiling of the spring around the hub.

Advantageously, the device comprises trigger means, suitable for keeping the carriage in the loading position by countering the return force due at least to a coil spring, to make it possible to position a drone on the carriage, and suitable for releasing the carriage to launch the drone.

Advantageously, the device comprises damping means, the carriage in end-of-travel position being held against the damping means by the return force exerted by the at least one spring, the damping means being configured to decelerate the carriage in proximity to the end-of-travel position.

Advantageously, the damping means comprise a set of plate springs, arranged against a set of abutments; the carriage crushing the set of plate springs at the end of travel.

Advantageously, the hub is rotationally mobile relative to the rail.

Advantageously, the carriage is translationally mobile on the rail by means of plain bearings. The bearings and the rail will advantageously be covered with a PTFE coating.

Advantageously, the spring mechanism comprises two coil springs around two hubs, the two coil springs being arranged back-to-back, the axes of rotation of the hubs of each of the springs being parallel in pairs and at right angles to the longitudinal axis.

Advantageously, the device comprises a manual arming mechanism for displacing the carriage from its end-of-travel position to its loading position.

Advantageously, the device comprises two handles allowing an operator to hold the device and a drone placed on the carriage and proceed to launch the drone.

The invention relates also to a system consisting of the launch device described previously, of a drone and of a control station, for example intended for observation missions.

The invention relates finally to a method for launching a drone by an operator by means of a device having the characteristics described previously, characterized in that the operator, at the time of the launch, holds the device crosswise; the longitudinal axis of the device being substantially parallel to the two shoulders of the operator.

The invention will be better understood and other advantages will become apparent on reading the detailed description of the embodiments given by way of example in the following figures.

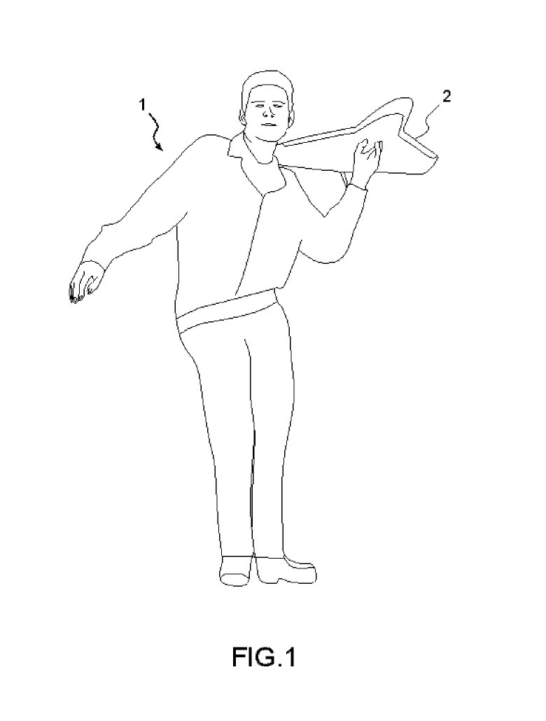

FIG. 1 illustrates a method for manually launching a drone according to the prior art,

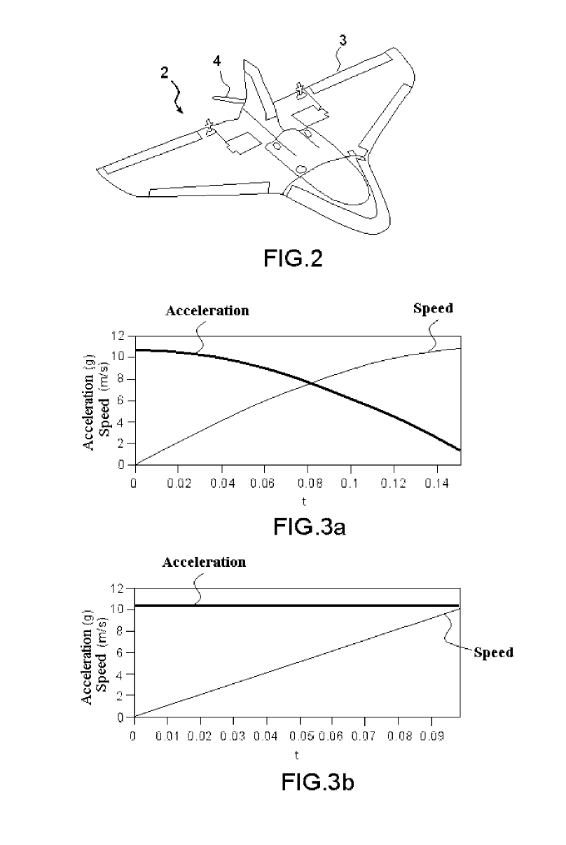

FIG. 2 represents an exemplary drone for which the launch device according to the present invention is intended,

FIGS. 3a and 3b illustrate the benefit of a launcher with constant acceleration,

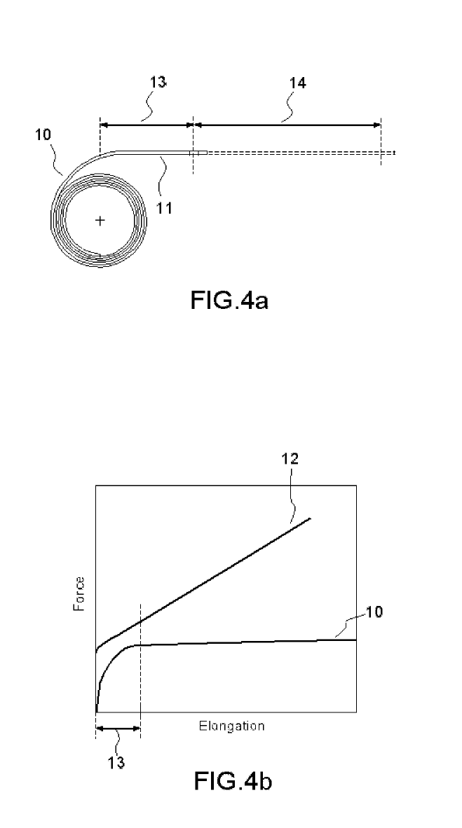

FIGS. 4a and 4b illustrate the principle of a coil spring,

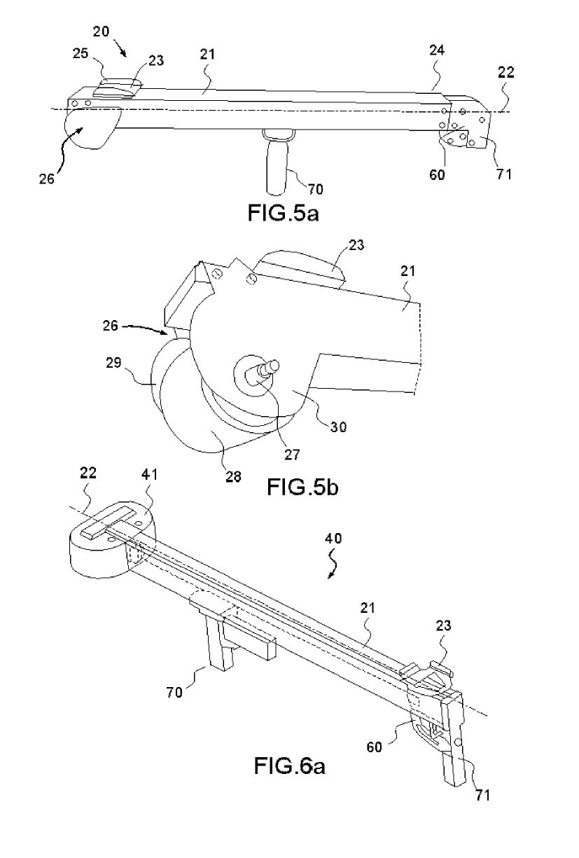

FIGS. 5a and 5b represent a first embodiment of a drone launch device according to the invention,

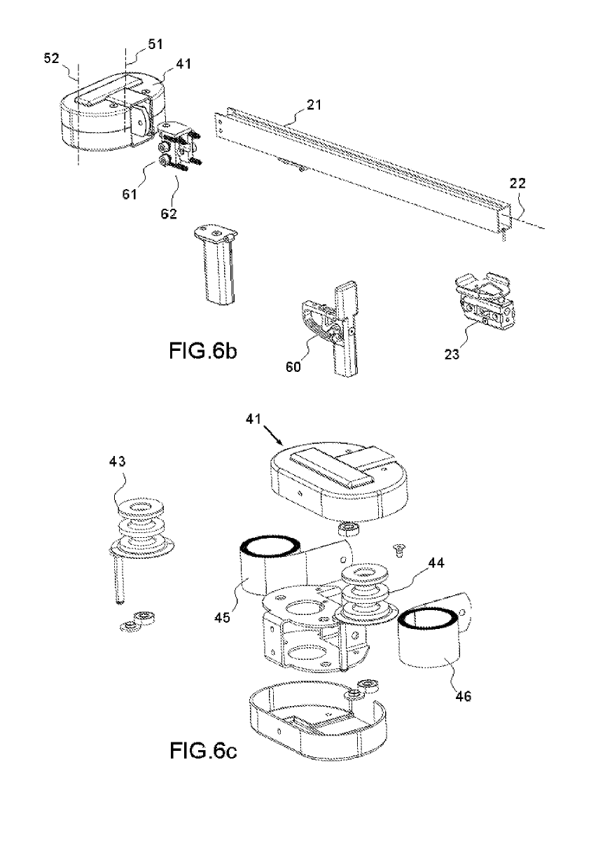

FIGS. 6a, 6b and 6c represent a second embodiment of a drone launch device according to the invention.

In the interests of clarity, the same elements will bear the same references in the various figures.

FIG. 1 illustrates a method for manually launching a drone. In this known method, an operator 1 proceeds manually to launch a drone 2 by imparting the highest possible speed thereon. The difficulties of such an approach can easily be understood. A drone of very small size requires a precise gesture that is difficult to perform repeatedly. Conversely, when the drone to be launched has a weight greater than a few kilograms, it proves difficult to launch it with sufficient force. In stress conditions, or even when the environment available for the launch by the operator is restricted or a precise launch trajectory is necessary, a significant launch failure rate is observed. The human factor is also a source of dispersion, not all operators having the same faculty to reproduce the launch gesture.

FIG. 2 represents an exemplary drone for which the launch device according to the present invention is intended. The drone 2 represented in FIGS. 1 and 2 by way of example is a drone dedicated to observation missions. As is known, the drone 2 comprises a set of aerodynamic control surfaces 3 and propulsion means, here, a propeller 4. The drone has a set of equipment items on board, generally including a positioning system of GPS type, an attitude unit, also known by the acronym AHRS, which stands for Attitude and Heading Reference System, making it possible to determine the attitude of the drone, a drone piloting unit, a camera device (infra-red and/or visible), or even a system allowing for the exchange of data with a remote operator (flight control, designation, exchange of digital data of video type, etc.). In a known mode of operation, an autopilot function activated by the operator before the launch controls the switching on of the motor when the drone has acquired a predetermined speed. If the operator does not manage to impart a sufficient speed on the drone, the motor is not switched on and the launch fails. Note also that some onboard equipment items are sensitive to the accelerations of the drone, as is notably the case with the attitude unit which cannot guarantee its measurement when the drone undergoes an excessively strong acceleration. If the acceleration at launch is too strong, the autopilot function cannot correct the trajectory of the drone at the time of the launch. The proper way to proceed is therefore, on the one hand, to impart a speed on the drone which is sufficiently high, and on the other hand, to contain the maximum acceleration, while minimizing as far as possible the length of the launch ramp.

This type of observation drone represented in FIG. 2 is generally of small size (typically with a span less than 1 m), and of limited weight (typically less than 2.5 g). Also known are much larger drones, for example drones flying at high altitude and of great endurance, commonly referred to by the acronym HALE which stands for High Altitude Long Endurance, which can reach a rate of several hundreds of kilograms for a span of several meters. The invention is primarily intended for the drone of small size transported by the operator to the places of the mission. That should not however constitute a limitation on the present invention, the launch device according to the invention being able to be applied according to the same principle to any type of drone.

The aim of FIGS. 3a and 3b is to illustrate the benefit of a launcher with constant acceleration. In the two graphic representations 3a and 3b, the trends of the speed and of the acceleration over time are represented, obtained by computation in the case of a standard elastic-band-powered launcher (FIG. 3a) and in the case of a launcher with constant acceleration (FIG. 3b).

In both cases, the aim is to achieve the speed of 10 m/s while limiting the acceleration to a value close to 10 g. In the first case, the computation assumes a launch ramp of a length equal to one meter, and an elastic band whose stiffness is defined to remain less than 10 g over a length of 2 meters (imagine the elastic band folded on itself over the length of the ramp). In the second case, the computation assumes a launch ramp of a length equal to 50 cm, and an acceleration assumed constant and close to the value of 10 g. In other words, a target speed of 10 m/s subject to the constraint of a maximum acceleration close to 10 g is achieved over a length of 50 cm assuming acceleration to be constant, whereas it is achieved over a length close to 1 meter (length of elastic band elongation of 2 meters) in the case of an elastic band of standard stiffness. This is all the more true when, with an elastic band, greater margins of error linked to the variations of characteristics thereof have to be considered.

FIGS. 4a and 4b illustrate the principal of a coil spring. The present invention implements a coil spring 10 consisting of a metal strip 11, for example of stainless steel, coiled on itself. This spring, manufactured by the coiling of the metal strip 11 on a reel, exerts a virtually constant force to withstand unwinding. As represented in FIG. 4b, the advantage of the coil spring compared to a traditional wire spring 12 lies in the fact that the exercise of a virtually constant force throughout the extension, or travel 14, with an initial elongation 13 which is short makes it possible to achieve the desired load over a short extension but with a great extension capacity.

In a preferred embodiment a spring with constant force is implemented, the return force of which exhibits a maximum deviation less than 10% of its nominal value, over a travel used 14 of the spring mechanism, beyond a minimum elongation value 13 representing less than 10% of the travel used 14.

FIGS. 5a and 5b represent a first embodiment of a drone launch device according to the invention. The device 20 comprises a rail 21 extending along a longitudinal axis 22 and a carriage 23 that is mobile on the rail 21. The aim of the carriage 23 is to receive the drone 2 to be launched, supporting it essentially by gravity, and to launch it by acceleration of the carriage 23 between a loading position 24 and an end-of-travel position 25. The two positions 24 and 25 are represented in FIG. 5a and respectively represent the extreme right position of the carriage on the rail and the extreme left position of the carriage on the rail. FIGS. 5a and 5b represent the carriage 23 in the end-of-travel position 25.

The device 20 further comprises a spring mechanism 26 configured to exert a return force on the carriage 23 along the longitudinal axis 22 that is substantially constant between the two positions 24 and 25. Advantageously, the spring mechanism 25 comprises a hub 27 and a coil spring 28 linked on the one hand to the carriage 24, and on the other hand coiled around the hub 26, the return force exerted on the carriage 23 being generated by the coiling of the spring 28 around the hub 27, the spring 28 having a travel at least equal to the travel of the carriage 24. In other words, the spring mechanism 26 comprises a coil spring 28 around a hub 27, an end of the coil spring 28 being linked to the carriage 23. Advantageously, the hub 27 is rotationally mobile relative to the rail 21. Alternatively, the hub can be fixed, even though the control of friction is, in this case, a priori more difficult.

In this embodiment, the spring 28 consists of a metal strip that can be extended under the rail and parallel thereto. Logically, the hub and the portion of spring 28 coiled thereon, are arranged in proximity to the end-of-travel position of the carriage. Advantageously, the hub 26 is rotationally mobile relative to the rail about an axis substantially at right angles to the longitudinal axis 22. The hub is, for example, linked to two lateral extensions 29 and 30 of the rail 21 by means of a rotational link, produced for example by mechanical rolling bearings.

FIGS. 6a and 6b represent a second embodiment of a drone launch device according to the invention. This device 40 comprises a certain number of components that are identical to the first embodiment. For these components, the same references correspond to the same components described for the first embodiment. Thus, this second device 40 comprises a rail 21 extending along a longitudinal axis 22 and a carriage 23 that is mobile on the rail 21, that can support and launch a drone by acceleration of the carriage 23 between the loading position 24 and the end-of-travel position 25. FIG. 6a represents the carriage 23 in the loading position 24.

Unlike the first embodiment, the spring mechanism here comprises two coil springs 45 and 46 arranged around two hubs 43 and 44. As represented in FIG. 6c in exploded fashion, the two coil springs 45 and 46 are arranged back-to-back. Logically, the axes of rotation 51 and 52 of the hubs 43 and 44 are parallel in pairs and at right angles to the longitudinal axis 22. The metal strips extend out of their respective hubs in parallel under the rail. In one possible implementation of the invention, the metal strips of the two springs are in contact over a portion of their length, and notably by their end linked to the carriage. The two metal strips in contact can be linked to the carriage by this portion by means of a common fixing. This configuration with two spring mechanisms back-to-back is particularly advantageous because it makes it possible to neutralize the spurious loads and torques generated by the springs outside of the longitudinal axis. In other words, the return force of a single spring cannot be perfectly aligned on the longitudinal axis, and this results in unwanted loads and/or torques outside of this axis. This architecture makes it possible, by having the springs back-to-back, to neutralize these unwanted loads and torques which are a source of friction, of lesser efficiency, and of premature wear of the device.

In the two embodiments represented in FIGS. 5a, 5b, 6a, 6b and 6c, the launch device comprises trigger means 60, suitable for keeping the carriage 23 in the loading position 24 by countering the return force of the coil spring or springs, to make it possible to position a drone on the carriage 23, and suitable for releasing the carriage for the launching of the drone. Think typically of a mechanical trigger system as represented in FIGS. 5a, 6a and 6b. Any other known keeping and triggering device, mechanical or not, also being envisaged by the invention.

To interrupt the travel of the carriage at the end of travel, the launch device also comprises damping means 62 configured to decelerate the carriage 23 in proximity to the end-of-travel position 25, the carriage in the end-of-travel position being held against these damping means 62 by the return force exerted by the spring or springs. To limit the force of the impact of the carriage against this set of abutments, and avoid premature wear of the carriage or of the abutments, the damping means 62 advantageously comprises a set of plate springs, commonly called Belleville springs, or Belleville washers, arranged against a set of abutments 61. It is envisaged to have a number of stacks of Belleville washers against the set of abutments 61. Alternatively, helical springs, arranged against the set of abutments 61, will also be able to be implemented. For these two embodiments, the damping means 62 are secured to the rail in proximity to the end-of-travel position 25 of the carriage 23. The set of springs is then arranged against the set of abutments 61 of the damping means. In an alternative implementation of the invention, it is envisaged to have the set of springs on the carriage 23, such that the springs crush against the set of abutments when the carriage is in the end-of-travel position. In other words, in this implementation, the damping means comprise a set of abutments fixed to the rail in proximity to the end-of-travel position, and a set of springs arranged on the carriage; the carriage crushing the set of springs, of Belleville washer and helical spring type, against the set of abutments.

The carriage 23 in the end-of-travel position 25 crushes the set of helical springs. This embodiment of the damping means by helical springs is in no way limiting on the present invention and any other damping means is also envisaged by the present invention. It may, for example, be a pneumatic or hydraulic damper. The damping device may also accommodate a wear marker or a usage counter.

The device also comprises an arming mechanism for displacing the carriage from its end-of-travel position to its loading position, and thus arming the launch device. A mechanical means (handle) allowing for the gripping of the carriage and the manual arming is envisaged for embodiments of small power. For larger embodiments, also envisaged is a mechanical system with or without gear reduction making it possible to pull the carriage by countering the return force of the spring.

In a preferred embodiment, the rail 21 is provided with plain bearings, for example of PTFE, making it possible to limit the frictions linked to the translation of the carriage on the rail, while representing a limited weight. For embodiments of larger size, bearings using other known technologies can be chosen.

As has been specified, the device is intended notably for the launching of drones of small size. For these drones of limited span and weight a launch device that can be carried by an operator is envisaged. To this end, the device comprises two handles 70 and 71 enabling an operator to hold the device and a drone placed on the carriage and to proceed with the launching of the drone.

The invention relates also to a system consisting of a device having the features described previously, a drone and a control station.

Finally, the invention relates also to a method for launching a drone by an operator by means of a device having the features described previously, characterized in that the operator, at the time of the launch, holds the device crosswise. In this posture, the operator carries the device by its two handles, facing him or her, and in such a way that the longitudinal axis is parallel to an axis passing through the two shoulders of the operator.

1. A device intended to launch a drone, comprising a rail extending along a longitudinal axis and a carriage mobile on the rail, that can support and launch a drone by the acceleration of the carriage between a loading position and an end-of-travel position,
further comprising a spring mechanism comprising at least one coil spring, configured to exert a return force on the carriage along the longitudinal axis that is substantially constant between the two positions.

2. The device as claimed in claim 1, wherein the return force exhibits a maximum deviation less than 10% of a nominal value, over a travel used of the spring mechanism, beyond a minimum elongation value representing less than 10% of the travel used.

3. The device as claimed in claim 1, wherein the spring mechanism comprises at least one coil spring around a hub, one end of the coil spring being linked to the carriage the return force exerted on the carriage being generated by the coiling of the spring around the hub.

4. The device as claimed in claim 3, comprising trigger means, suitable for keeping the carriage in the loading position by countering the return force due at least to a coil spring, to make it possible to position a drone on the carriage, and suitable for releasing the carriage to launch the drone.

5. The device as claimed in claim 3, comprising damping means, the carriage in end-of travel position being held against the damping means by the return force exerted by the at least one spring, the damping means being configured to decelerate the carriage in proximity to the end-of-travel position.

6. The device as claimed in claim 5, wherein the damping means comprise a set of plate springs, arranged against a set of abutments the carriage crushing the set of plate springs at the end of travel.

7. The device as claimed in claim 5, wherein the damping means comprise a set of abutments fixed to the rail in proximity to the end-of-travel position, and a set of plate springs arranged on the carriage; the carriage crushing the set of plate springs against the set of abutments at the end of travel.

8. The device as claimed in claim 1, wherein the hub is rotationally mobile relative to the rail.

9. The device as claimed in claim 1, wherein the carriage is translationally mobile on the rail by means of plain bearings.

10. The device as claimed claim 3, wherein the spring mechanism comprises two coil springs around two hubs, the two coil springs being arranged back-to-back, the axes of rotation of the hubs of each of the springs being parallel in pairs and at right angles to the longitudinal axis.

11. The device as claimed in claim 1, comprising a manual arming mechanism for displacing the carriage from its end-of-travel position to its loading position.

12. The device as claimed in claim 1, comprising two handles allowing an operator to hold the device and a drone placed on the carriage and to proceed to launch the drone.

13. A system comprising a device as claimed in claim 1, a drone and a control station.

14. A method for launching a drone by an operator by means of a device as claimed in claim 1, wherein the operator, at the time of the launch, holds the device crosswise; the longitudinal axis of the device being substantially parallel to the two shoulders of the operator.
